(19) United States
(12) Patent Application Publication
(10) Pub. No.: US 2025/0278398 A1
(43) Pub. Date: Sep. 4, 2025

(54) METHOD AND SYSTEM FOR EVENTUAL CONSISTENCY OF DATA TYPES IN GEO-DISTRIBUTED ACTIVE-ACTIVE DATABASE SYSTEMS

(71) Applicant: HUAWEI CLOUD COMPUTING TECHNOLOGIES CO., LTD., Gui Zhou Province (CN)

(72) Inventors: Daniel Kent HOUSE, Kanata (CA); Heng KUANG, Kanata (CA); Ming CHEN, Kanata (CA); Kajaruban SURENDRAN, Kanata (CA); Huazu WEI, Kanata (CA)

(73) Assignee: HUAWEI CLOUD COMPUTING TECHNOLOGIES CO., LTD., Gui Zhou Province (CN)

(21) Appl. No.: 19/190,053

(22) Filed: Apr. 25, 2025

Related U.S. Application Data
(63) Continuation of application No. PCT/CN2022/133309, filed on Nov. 21, 2022.

(51) Int. Cl. G06F 16/23; G06F 16/27

(52) U.S. Cl. CPC G06F 16/2365; G06F 16/27

(57) ABSTRACT

There is provide a method and system for eventual consistency of data types in geo-distributed active-active database systems. A multi-type conflict-free replicated data type (CRDT) structure is provided. The multi-type CRDT structure and method allow a geo-distributed active-active database system to reach eventual consistency on data type conflicts by supporting multiple incompatible data types.

### CROSS-REFERENCE TO RELATED APPLICATIONS

This application is a continuation of International Patent Application No. PCT/CN 2022/133309, filed on Nov. 21, 2022, entitled “Method and System for Eventual Consistency of Data Types in Geo-Distributed Active-Active Database Systems”, the entire content of which is incorporated herein by reference.

### TECHNICAL FIELD

The present disclosure relates to systems and methods for data management in an active-active architecture, including systems and methods for cross-region active-active data replication between services in cloud computing.

### BACKGROUND

An Active-Active network architecture is a data resiliency architecture that distributes the database information over multiple data centers via independent and geographically distributed clusters and nodes. It is a network of separate processing nodes, each having a replica of a database (or cache) such that all nodes can participate in a common application ensuring local low latency with each region being able to run in isolation.

However, concurrent updates to multiple replicas of the same data in active-active systems, without coordination between the computers hosting the replicated databases, may result in inconsistencies between the replicas. Restoring eventual consistency and data integrity when there are conflicts between updates may require some or all of the updates to be entirely or partially rejected.

Eventual consistency is a consistency model used in distributed computing to achieve high availability that informally guarantees that, if no new updates are made to a given data item, eventually all accesses to that item will return the same value in all replicas. Eventual consistency, also called optimistic replication, is deployed in distributed systems and has origins in early mobile computing projects. A system that has achieved eventual consistency is often said to have converged or achieved replica convergence.

Much of distributed computing focuses on the problem of how to prevent concurrent updates to replicated data of a database or cache. Another possible approach is optimistic replication, where all concurrent updates of the database or cache may be allowed to go through, with inconsistencies possibly created, and the results are merged or “resolved” later. In this approach, consistency between the replicas may be eventually re-established via “merges” of differing replicas.

Distributed active-active database system may require a live and fast bi-directional data replication between regions. It is possible for two parts of a system to attempt to create the same data-item with different types, causing a conflict. When communication links are temporarily blocked (for example, during a network partition) there may be multiple conflicts for the same data. However, all data-items must always remain available to all parts of the database system. Data in all regions must eventually be consistent after replication. The conflict identification and resolution for data changes must be fast.

Conflict-free replicated data type (CRDT) is a type of data structure that enables conflict resolution among database or cache operations including writing commands, deleting commands, updating commands, when replicating data and metadata across multiple service instances. CRDT data structures may be implemented using a CRDT module (which may also be referred to as a CRDT agent) that adds to the functionality of an existing data store. The CRDT module may be loaded and initialized when a cache service instance is started up.

Operation-based CRDTs may transmit only the update operations, which may be small. Operation-based CRDTs make strong assumptions about the reliability of communications and require guarantees from the communication middleware; that the operations are not dropped or duplicated when transmitted to the other replicas, and that they are delivered in causal order. Therefore, the communication infrastructure must ensure that all operations on a replica are delivered to the other replicas, without duplication, and in causal order.

State-based CRDTs are called convergent replicated data types. State-based CRDTs are often simpler to design and implement. Their drawback is that the entire state of every CRDT must be transmitted eventually to every other replica, which may be costly for example in both infrastructure required and time required.

Cloud applications have a high demand for geo-distributed active-active databases to provide global, reliable, and high-performance services. If two regions of a geo-distributed active-active database system create the same data-item with different types, then a data type conflict resolution mechanism is required to guarantee eventual consistency between those regions. Otherwise, applications developers have to change business logic and follow specific usage patterns to avoid data type conflict.

Some conventional CRDTs avoid conflict by requiring system design to take specific steps (specific usage patterns) to ensure that conflict never arises. Database providers have to state the behavior and constraints of resolving data type conflict in their user guide, as applications need to adapt to them.

Some conventional CRDTs handle individual types of data restricting eventual consistency to a single instance of a single type. Some other conventional CRDTs support multiple data types by using different name-spaces. However, segregating data-items by type using name-spaces may force developers to create and manage multiple name-spaces. Some conventional CRDTs make strong assumptions about the reliability of communications.

Therefore, there is a need for a method and a system for implementing a conflict-free replicated data type structure capable of supporting multiple incompatible data types and ensure data consistency in the presence of mixed data types. Such a CRDT structure may obviate or mitigate one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

The present disclosure is directed to a method and system for eventual consistency of data types in geo-distributed active-active database systems. A multi-type conflict-free replicated data type (CRDT) structure is provided. The multi-type CRDT structure and method allow a geo-distributed active-active database system to reach eventual consistency on data type conflicts by supporting multiple incompatible data types. The multi-type CRDT structure handles multiple types simultaneously without segregating the instances of the various CRDT data types, and only assumes ordered, eventual delivery on individual point-to-point channels.

According to an aspect, there is provided a method for conflict free replicated data type management in a database system including multiple data center nodes. The method includes receiving, by a message handling function associated with a data center node, a request message defining a request relating to a data item, the data item defined without a data type or defined with one or more data types, wherein a priority sequence is associated with the one or more data types. The method further includes performing, by the message handling function, one or more actions based on an evaluation of the request.

In some embodiments, the step of performing includes determining, by the message handling function, if the request includes a get-current-type request associated with the data item. Upon determining the data item has a data type based at least in part on the priority sequence, the step of performing further includes reporting, by the message handling function, the data type associated with the data item. Upon determining the data item has no data type, the step of performing further includes reporting, by the message handling function, the data item has no data type.

In some embodiments, the step of performing includes determining, by the message handling function, if the request includes a clear request associated with the data item. Upon determining the request is a clear request, the step of performing includes clearing, by the message handling function, one or more values associated with the data item, clearing, by the message handling function, one or more attributes associated with the data item. Upon determining the request is a clear request, the step of performing further includes building, by the message handling function, a merge-clear message based on the clearing of the one or more values and the one or more attributes and sending, by the message handling function, a merge-clear request associated with the data item to all other data center nodes in the database system.

In some embodiments, upon determining the request is a not a clear request, the step of performing includes determining, by the message handling function if the data item has a data type. Upon determining the data item has no data type and the request has a meaning, the step of performing further includes applying, by the message handling function, a change to a value associated with the data item as defined by the request and applying, by the message handling function, a change to an attribute associated with the data item as defined by the request. Upon determining the data item has no data type and the request has a meaning, the step of performing further includes sending, by the message handling function, a merge request associated with the data item to all other data center nodes in the database system.

In some embodiments, upon determining the data item has a data type based at least in part on the priority sequence and a current data type associated with the data item matches a data type defined in the request the step of performing includes applying, by the message handling function, a change to a value associated with the data item as defined by the request and applying, by the message handling function, a change to an attribute associated with the data item as defined by the request. Upon determining the data item has a data type and a current data type associated with the data item matches a data type defined in the request the step of performing further includes sending, by the message handling function, a merge request associated with the data item to all other data center nodes in the database system.

In some embodiments, upon determining the data item has a data type based at least in part on the priority sequence and a current data type associated with the data item is different than a data type defined in the request, the step of performing includes rejecting, by the message handling function, the request.

In some embodiments, the request message is associated with a read request. In some embodiments, the data item can include multiple values and multiple data types, wherein the data types are incompatible.

According to an aspect there is provided a data center node associated with a database system. The data center node includes a processor and a memory including machine executable instructions stored thereon. The machine executable instructions, when executed by the processor configure the data center node to perform one or more of the above defined methods.

According to an aspect there is provided a database system including a plurality of data base center nodes. Each data center node including a processor and a memory including machine executable instructions stored thereon. The machine executable instructions, when executed by the processor configure a particular data center node to perform one or more of the above defined methods.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 is a block diagram of a geographically distributed database system, according to embodiments.

FIG. 2 is a block timeline diagram showing an example of a data type conflict caused by geographically separated databases in Asia and Africa creating the same data-item with different types and values, according to embodiments.

FIG. 3 is a logic diagram for resolving a data type conflict, according to embodiments.

FIG. 4 is a block timeline diagram showing an example of a data type conflict resolved after a CLEAR operation is delivered, according to embodiments.

FIG. 5 is a block timeline diagram showing an example of non-causal delivery leading to an attribute without a value, according to embodiments.

FIG. 6 is a block diagram of an electronic device, according to embodiments.

### DETAILED DESCRIPTION

Embodiments of the present disclosure provide a method and system for eventual consistency of data types in geo-distributed active-active database systems. A multi-type conflict-free replicated data type (CRDT) structure is provided. The multi-type CRDT structure and method allow a geo-distributed active-active database system to reach eventual consistency on data type conflicts by supporting multiple incompatible data types. The multi-type CRDT structure handles multiple types simultaneously without segregating the instances of the various CRDT data types, and only assumes ordered, eventual delivery on individual point-to-point channels.

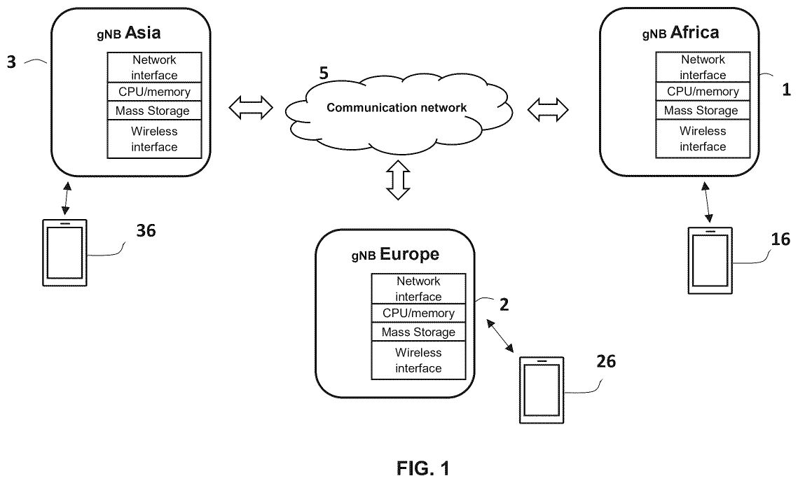

FIG. 1 illustrates a block diagram of a geographically distributed database system, according to embodiments. The distributed database system includes multiple geographically separated data center nodes including gNB Asia 3, the gNB Europe 2 and the gNB Africa 1 Although the data center nodes are shown as being a gNB, other types of data center node configurations can be used in some embodiments, with the data center nodes generally providing access to communication and other services via a communication interface. The geographically separated data center nodes gNB Asia 3, the gNB Europe 2 and the gNB Africa 1 are communicatively connected via a communication network 5, which provides a means for the coordination of replication of data across the geographically separated data center nodes associated with the geographically distributed database system. A customer, for example a user equipment (UE), in a particular geographical region can perform tasks such as interacting with an associated geographic data center node using a communication network (not illustrated). For example, customer 36 communicates with gNB Asia 3, customer 26 communicates with gN B Europe 2 and customer 16 communicates with gNB Africa 1

It has been realised that cloud applications may have a high demand for geo-distributed active-active database to provide global, reliable, and high-performance services. As such, if two regions of a geo-distributed active-active database system create the same data item with different types, then a data type conflict resolution mechanism is required to guarantee eventual consistency between those regions.

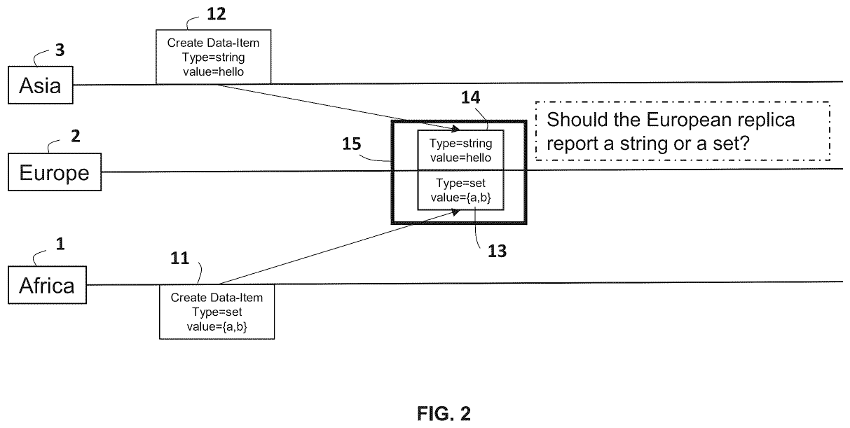

FIG. 2 is a block timeline diagram showing an example of a data type conflict caused by geographically separated databases in Asia and Africa creating the same data-item with different types and values, according to embodiments. In FIG. 2 the block timeline diagram shows an example of a data type conflict caused by clients in the Africa data center node 1 and the Asia data center node 3. The data center nodes 1-3 host replicas of a database. For example, the Europe data center node 2 maintains a database 15. The Asia and the Africa data center nodes also maintain replicas of the database 15. The Africa data center node 1 creates a data-item 11 with a data value set to “{a,b}”, and a data type defined as “set”. The Asia data center node 3 creates the same data-item (which is marked as a data-item 12) with the data value set to “hello”, and the data type defined as a “string”. The Africa data center node 1 reaches out to the Europe data center node 2 and replicates there its data-item 11 as an instance 13, while the Asia data center node 3 replicates at the Europe data center node 2 its data-item 12 as an instance 14. The instances 13 and 14 may be created at the database 15 at the same time or at different times. With the data-item at the Europe data center node database replica 15 having more than one data type, the database replica 15 needs a method to determine a data type to report to a client. If such data type conflicts are not resolved quickly and efficiently, there can be customer complaints.

The present disclosure provides a method and a system to attain an eventually consistent data presentation at all the data centers hosting database replicas. The method to attain the eventually consistent data presentation is a multi-type CRDT. The multi-type CRDT method and system facilitate a systematic approach to resolve data type conflicts instead of managing a large number of instances of data types that may be added and deleted from maps such as a key-value store distributed over large geographic areas. The multi-type CRDT method does not restrict customers to specific usage patterns (no need to modify business logic), and may ease adding new data types to a database. Consistency may be attained during a READ operation by executing a type-conflict resolution procedure.

According to some embodiments of the present disclosure an instance of a multi-type CRDT structure is referred to as a data-item. Externally, the multi-type CRDT structure may have a data type or no data type. At different times, the multi-type CRDT structure may have different external data types. Internally, the multi-type CRDT structure may have no data type or a plurality of data types. Thus, the multi-type CRDT structure may have more than one internal data type at the same time. And a list of internal data types associated with a data-item may change over time.

According to embodiments, the internal CRDT data types are arranged in a priority sequence. When a data-item (a multi-type CRDT structure) has more than one internal data type, a one-time conflict resolution may be performed every time the data-item is accessed. For example, in one embodiment of the multi-type CRDT structure the internal CRDT data types can be strings and counters, with strings having priority over counters. In another embodiment the internal CRDT data types can be sets, lists and maps, where priority order can be defined as maps have priority over lists and set and wherein lists have priority over sets.

According to embodiments, externally, the multi-type CRDT structure may have an attribute or no attributes. At different times, the multi-type CRDT structure may have different external attributes. Internally, the multi-type CRDT structure may have no attributes or a plurality of attributes. Thus, the multi-type CRDT structure may have more than one internal attribute at the same time. A list of internal attributes, associated with the data-item, may change over time. The multi-type CRDT structure attributes are independent of its data types. Attributes of the multi-type CRDT structure may have attribute types.

According to the present disclosure, a multi-type CRDT structure may have no internal data value, no internal data type, and no internal attributes. Such multi-type CRDT structure is described as “empty”. The empty multi-type CRDT structure may have no external data value, no external data type, and no external attributes.

In some embodiments of the present disclosure a multi-type CRDT structure may have an external data value if the data-item (the multi-type CRDT structure) has at least one internal data value with a data type and no attributes.

In some embodiments a multi-type CRDT structure may have a data type only if it has a data-value.

In the present disclosure, a local client is defined as a client in geographical proximity to a particular data center node, for example client 16 to the Africa data center node 1 In this case, the Africa data center node 1 is a local data center.

In some embodiments the disclosed method may define a set of internal data types. The set of internal date types of the multi-type CRDT structure may be arranged in sequential hierarchy (for example a precedence order). For every pair of distinct internal date types, one internal data type has precedence over the other data type. Further, the method may determine a set (which may possibly be empty) of internal attributes. Each internal attribute may have at least one attribute type.

According to embodiments, each data type of the multi-type CRDT structure (for example both internal data types and external data types) may be accompanied by a set of local operations that return output information to a local client and information that may be sent to all remote replicas of a particular database. The information, communicated to the remote replicas, may specify a remote operation to be performed on instances with the matching data type (or matching data types) at each remote replica. For read-only local operations, information regarding any changes may not be sent to the remote replicas. According to embodiments, a requirement on an instance in a remote replica of a data item is that the remote replica data item has a multi-type CRDT structure. For example, an improvement provided by a multi-type CRDT structure is that even when a remote instance of a data item has a data type that does not match at the time the information is communicated (for example received from another data center regarding the particular data item), eventually both instances, of a data item (namely a data item present at a first database and the replica of that data item at another database) will have the same data type.

According to embodiments, a message handling function may facilitate communication of the generated information to the local client and the remote replicas of the local database. For example, a local operation CLEAR may place a local instance of the data-item (for example the multi-type CRDT structure) into an empty state. The disclosed method may define a read-only operation defined as EMPTY. When the multi-type CRDT structure is in an empty state, and the EMPTY operation is performed on such a structure, the EMPTY operation may return information indicative of a “true” status.

According to embodiments, the message handling function can be integrated together with the set of local operations thereby providing the desired operations and functionality according to various embodiments of the instant application. A message handling function may be configured as a function, for example an application, software, software/firmware, or other configuration, operating within each of the data center nodes thereby providing the desired functionality thereto. In some embodiments, a message handling function can be configured as an application program interface (API).

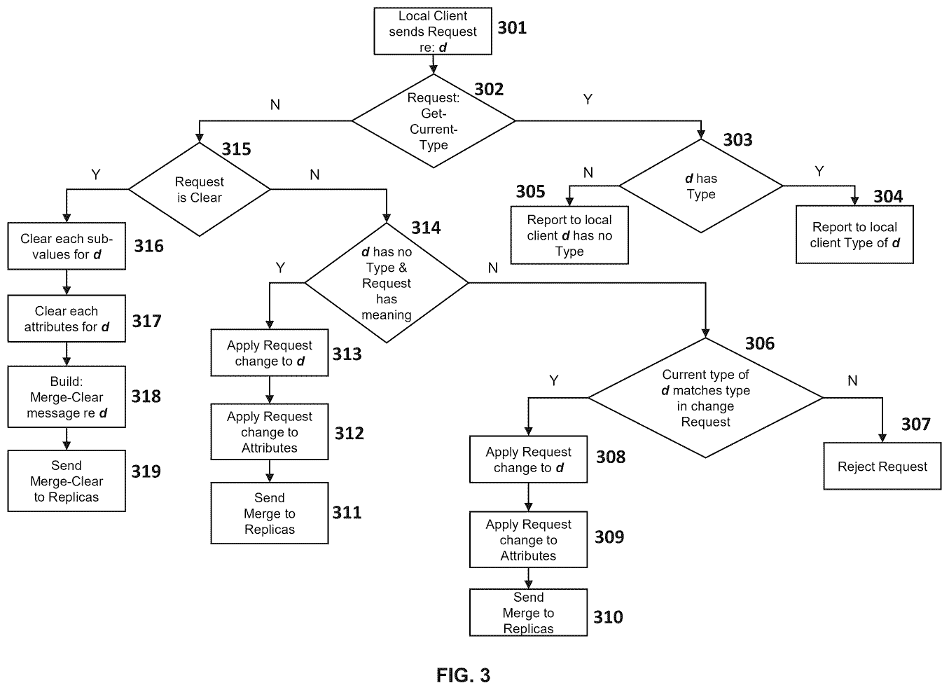

According to embodiments, using the above defined multi-type CRDT structure, a method for resolving a data type conflict is discussed herewith with respect to FIG. 3. FIG. 3 is a logic diagram for resolving a data type conflict, according to embodiments.

In some embodiments, a local client may send a request 301 to a local data center addressing a multi-type CRDT structure (a data-item-d). The request may be indicative of a GET-CURRENT-TYPE operation 302 At 303, if the multi-type CRDT structure does not currently have a data type 305, output information, communicated to the local client, may have an indication that the data-item (the multi-type CRDT structure) has no data type. If the multi-type CRDT structure has a current data type 304, the output information, communicated to the local client, may provide an indication of the current data type.

According to embodiments, a data type, for example a current data type of a data item may be determined based on a priority sequence that is associated with the data types associated with the multi-type CRDT structure, which is discussed in more detail elsewhere herein.

In some embodiments, the local client may send a request to the local data center addressing a multi-type CRDT structure (a data-item-d), and the request may be indicative of a CLEAR operation. At 315, if the request is a CLEAR operation, the CLEAR operation applied to the addressed multi-type CRDT structure may void each of data values 316 A MERGE-CLEAR message may be generated for every data value voided or cleared by the CLEAR operation.

According to embodiments, the CLEAR operation applied to the multi-type CRDT structure addressed by the request may void each of attributes 317. A MERGE-CLEAR message may be generated for every attribute voided by the CLEAR operation. Upon completion of this step all of the attributes and data values may report that they are empty. Furthermore, at this step the local replica (the addressed multi-type CRDT structure at the local database) may have no data type.

According to embodiments, the method may also include generating or building 318 a final MERGE-CLEAR message. The final MERGE-CLEAR message may contain all the MERGE-CLEAR messages generated after the CLEAR operation upon the application of this CLEAR operation to the addressed multi-type CRDT structure. The final MERGE-CLEAR message may consequentially be communicated or sent 319 to every remote replica of the addressed multi-type CRDT structure.

In some embodiments, a local client may send a request to the local data center addressing a multi-type CRDT structure (a data-item-d). At 314, the addressed multi-type CRDT structure may have no data type however the request may also be indicative of modifications that may have meaning, namely the modification of the data-item, regardless that the data-item has no associated value, an attribute change can have meaning, for example when an attribute is reflective of a time to live (TTL) associated with the data item.

According to embodiment, the method may further include validating the request and applying 313, 312 the requested modifications to the addressed multi-type CRDT structure. Furthermore, the method may include generating a plurality of MERGE messages after the requested modifications were applied to the addressed multi-type CRDT structure. For example, the requested modification may be applied to internal data values 313 and corresponding attributes 312

According to embodiments, the method may also include generating a final MERGE message. The final MERGE message may contain all the MERGE messages generated after the requested modifications were applied to the addressed multi-type CRDT structure. The final MERGE message may consequentially be communicated or sent 311 to every remote replica of the addressed multi-type CRDT structure.

In some embodiments of the method, a local client may send a request to the local data center addressing a multi-type CRDT structure (a data-item-d). The addressed multi-type CRDT structure may have a current data type. The request may have an indication of a data type matching the current data type 306 The request may also be indicative of modifications to be applied on the addressed multi-type CRDT structure. The method may further include validating the request and applying the requested modifications to the addressed multi-type CRDT structure 308, 309. For example, the requested modifications may be applied to internal data values 308 and corresponding attributes 309.

According to embodiments, the method may include generating a plurality of MERGE messages after the requested modifications were applied to the addressed multi-type CRDT structure with the current data type. The method may also include generating a final MERGE message. The final MERGE message may contain all the MERGE messages generated after the requested modifications were applied to the addressed multi-type CRDT structure with the current data type. The final MERGE message may consequentially be communicated or sent 310 to every remote replica of the addressed multi-type CRDT structure with the current data type.

In some embodiments of the method, a local client may send a request to the local data center addressing a multi-type CRDT structure (a data-item-d). The addressed multi-type CRDT structure may have a current data type, however the request may have an indication of a data type that does not match the current data type 306 In this instance, the request to the local data center addressing a multi-type CRDT structure is rejected 307.

In some embodiments of the instant application, a multi-type CRDT structure is hosted on a local data center node and a remote replica of the multi-type CRDT structure is hosted on one or more remote data center nodes. According to embodiments, a message handling function that is operational at a remote data center node may send a request to the local data center node addressing actions that are to be taken by the local data center node in association with the multi-type CRDT structure stored thereon. According to embodiments, a message handling function that is operational at a local data center node may send a request to one or more remote data center nodes addressing actions that are to be taken by the one or more remote data center nodes in association with the multi-type CRDT structure stored thereon.

In some embodiments, a remote data center node sends a MERGE request with regard to a data item (namely an addressed multi-type CRDT structure) stored on other data center nodes associated with the database system. In some embodiments, the MERGE request may be indicative of a MERGE-CLEAR operation. If the request is a MERGE-CLEAR, application of the MERGE-CLEAR operation may merge each of sub-messages into the corresponding attributes and optional-sub-values associated with the addressed multi-type CRDT structure. Upon completion thereof, the local replica (namely the addressed multi-type CRDT structure) at the local data center node may have a data type or may not have a data type. If the request is not a MERGE-CLEAR request, application of the MERGE request is performed thereby merging the request amendment into the indicated attribute or optional-sub-value that was associated with the request.

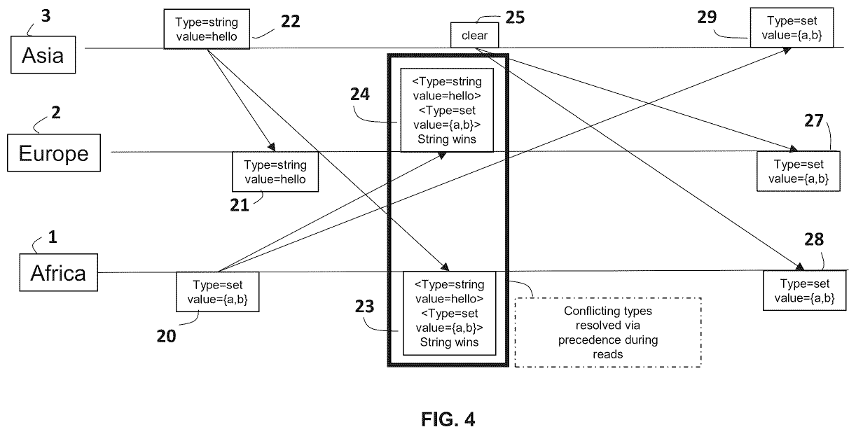

FIG. 4 is a block timeline diagram showing an example of a data type conflict resolved after a CLEAR operation is delivered, according to embodiments. The Africa data center node 1 hosts a data-item 20 with the date type defined as a “set”, and the data value defined as “{a,b}”. The Asia data center node 3 hosts the same data-item (marked as an instance 22) with the data type defined as a “string”, and the data value set to “hello”. The Asia data center node 3 contacts the Europe data center node 2 to duplicate data item 22 and creates an instance 21 with the type “string”, and the value “hello”. Consequentially or concurrently with the action performed by the Asia data center node 3, the Africa data center node 1 contacts the Europe data center node 2 to create a replica of the data-item 20. Consequently, the Europe data center node 2 hosts a multi-type CRDT structure 24 with the internal date types: “set” and “sting”, and the internal data values: “{a,b}” and “hello”.

The Asia data center node 3 also contacts the Africa data center node 1 to duplicate at the Africa data center node 1 the data-item 22 with the type “set”, and the value “{a,b}”. Consequently, the Africa data center node 1 hosts a multi-type CRDT structure 23 with the internal date types: “set” and “sting”, and the internal data values: “{a,b}” and “hello”.

According to embodiments, a data type conflict (as seen in the multi-type CRDT structures 23 and 24) may be resolved via precedence order (for example a sequential hierarchy) applied during or prior to an instructed READ operation.

The Asia data center node 3 receives a message 25 from a local client. The message is indicative of a CLEAR operation. Upon validation and execution of the CLEAR operation, the data type, and the data value of the instance (e.g. the data-item) 22 is voided or cleared. Furthermore, upon completion of the CLEAR operation, a message handling function at the Asia data center node 3 generates a message indicative of a MERGE-CLEAR operation, which is communicated to other data centers hosting replicas of the data-item 22 The message indicative of the MERGE-CLEAR operation is sent to the Europe and Africa data center nodes. Upon receipt of this message, the instances with the data types and data values matching the data type “string” and the data value “hello” of the data-item 22 are voided or cleared. Consequently, the multi-type CRDT structure 24 (e.g. the data-item 24) at the Europe data center node 2 is updated to a new instance 27 with only one data type, and only one data value. The multi-type CRDT structure 23 (e.g. the data-item 23) at the Africa data center node 1 is updated to a new instance 28 with only one data type, and only one data value is therefore present.

At this moment in time, the data-item replicas 26-28 at the three data center nodes 1-3 have reached eventual consistency with the data type “set” and the data value “{a,b}”.

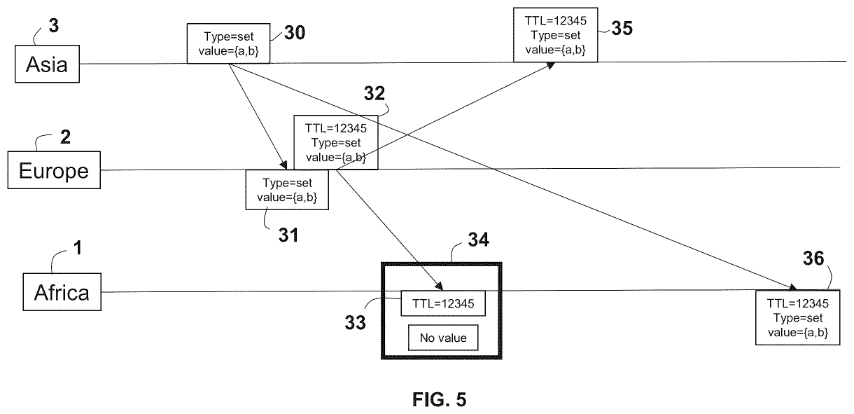

FIG. 5 is a block timeline diagram showing an example of non-causal delivery leading to an attribute without a value, according to embodiments. The Asia data center node 3 hosts a data-item 30 with the date type defined as a “set”, and the data value defined as “{a,b}”. This data item is transmitted to both the Europe data center node 2 and Africa data center node 1 wherein the receipt of this data item by the Europe data center node 2 results in the creation of data item instance 31 and receipt of this data item by the Africa data center node 1 results in the creation of data item instance 36. It is important to note the differences in timing with respect to the receipt and subsequent creation of the data item instance at the Europe data center node 2 and the data item instance at the Africa data center node 1 The Europe data center node 2 after receipt of the data item 31 MERGES an attribute of this data item which is reflective of a time to live (TTL) associated with the data item, resulting in the creation of data item instance 32 The Europe data center node 2 sends a modification request (namely a MERGE request to the other data center nodes (namely Europe data center node 2 and Africa data center node 1) wherein the request is to MERGE the attribute relating to the TTL with the data item received from the Asian data center node 3. At the Asia data center node 3 this MERGE request results in the creation of data item instance 35. However, as the Africa data center node 1 the MERGE request relating to the attribute (received from the Europe data center node 2) is received prior to the receipt of data item from the Asia data center node 3. The Africa data center node considers the MERGE request. Given that the data item has no value but the MERGE request has a meaning, the Africa data center node 1 creates data item instance 34 At a later time, the Africa data center node 1 receives the data item indicative of the data type defined as a “set”, and the data value defined as “{a,b}” from the Asia data center node 3. The Africa data center node 1 thus creates data item instance 36 which has a the data type defined as a “set”, and a data value defined as “{a,b}” together with an attribute TTL defined as “12345” together. At this time, there is an eventual consistency of data items across each of the geographically distributed data center nodes, namely the Asia data center node 3, the Europe data center node 2 and the Africa data center node 1

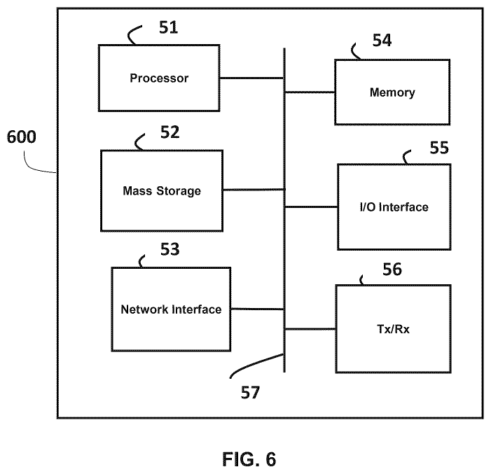

FIG. 6 is a block diagram of an electronic device 600 which can provide for the functionality of one or more components and further described elsewhere herein. For example, a computer equipped with network function may be configured as an electronic device 600. According to some embodiments, the electronic device 600 may correspond to parts of a customer, for example a user equipment (UE), or a data center node, or a data center node providing network access (e.g., a gNB), or a message handling function configured as a device and associated with a data center node.

As shown, the device 600 includes a processor 51, such as a central processing unit (CPU) or specialized processors such as a graphics processing unit (GPU) or other such processor unit, memory 54, non-transitory mass storage 52 I/O interface 55, network interface 53, and a transceiver 56, all of which are communicatively coupled via bi-directional bus 57. According to certain embodiments, any or all of the depicted elements may be utilized, or only a subset of the elements. Further, the device 600 may contain multiple instances of certain elements, such as multiple processors, memories, or transceivers. Also, elements of the hardware device may be directly coupled to other elements without the bi-directional bus. Additionally or alternatively to a processor and memory, other electronics, such as integrated circuits, may be employed for performing the required logical operations.

The memory 54 may include any type of non-transitory memory such as static random access memory (SRAM), dynamic random access memory (DRAM), synchronous DRAM (SDRAM), read-only memory (ROM), any combination of such, or the like. The mass storage element 52 may include any type of non-transitory storage device, such as a solid state drive, hard disk drive, a magnetic disk drive, an optical disk drive, USB drive, or any computer program product configured to store data and machine executable program code. According to certain embodiments, the memory 54 or mass storage 52 may have recorded thereon statements and instructions executable by the processor 51 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present disclosure. It is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations, or equivalents that fall within the scope of the present invention.

1. A method for conflict free replicated data type management in a database system including multiple data center nodes, the method comprising:
receiving, by a message handling function associated with a data center node, a request message defining a request relating to a data item, the data item defined without a data type or defined with one or more data types, wherein a priority sequence is associated with the one or more data types; and
performing, by the message handling function, one or more actions based on an evaluation of the request.

2. The method according to claim 1, wherein the step of performing includes:
determining, by the message handling function, if the request includes a get-current-type request associated with the data item;
upon determining the data item has a data type based at least in part on the priority sequence, reporting, by the message handling function, the data type associated with the data item; and
upon determining the data item has no data type, reporting, by the message handling function, the data item has no data type.

3. The method according to claim 1, wherein the step of performing includes:
determining, by the message handling function, if the request includes a clear request associated with the data item; and
upon determining the request is a clear request:
clearing, by the message handling function, one or more values associated with the data item;
clearing, by the message handling function, one or more attributes associated with the data item;
building, by the message handling function, a merge-clear message based on the clearing of the one or more values and the one or more attributes; and
sending, by the message handling function, a merge-clear request associated with the data item to all other data center nodes in the database system.

4. The method according to claim 1, wherein the step of performing includes:
upon determining the request is a not a clear request, determining, by the message handling function if the data item has a data type; and
upon determining the data item has no data type and the request has a meaning:
applying, by the message handling function, a change to a value associated with the data item as defined by the request;
applying, by the message handling function, a change to an attribute associated with the data item as defined by the request; and
sending, by the message handling function, a merge request associated with the data item to all other data center nodes in the database system.

5. The method according to claim 1, wherein the step of performing includes:
upon determining the data item has a data type at least in part based on the priority sequence and a current data type associated with the data item matches a data type defined in the request:
applying, by the message handling function, a change to a value associated with the data item as defined by the request;
applying, by the message handling function, a change to an attribute associated with the data item as defined by the request; and
sending, by the message handling function, a merge request associated with the data item to all other data center nodes in the database system.

6. The method according to claim 1, wherein the step of performing includes:
upon determining the data item has a data type at least in part based on the priority sequence and a current data type associated with the data item is different than a data type defined in the request:
rejecting, by the message handling function, the request.

7. The method of claim 1, wherein the request message is associated with a read request.

8. The method of claim 1, wherein the data item can include multiple values and multiple data types, wherein the data types are incompatible.

9. A data center node associated with a database system, the data center node comprising:
a processor; and
a memory including machine executable instructions stored thereon, the machine executable instructions, when executed by the processor configure the data center node to:
receive a request message defining a request relating to a data item, the data item defined without a data type or defined with one or more data types, wherein a priority sequence is associated with the one or more data types; and
perform one or more actions based on an evaluation of the request.

10. The data center node according to claim 9, wherein while performing one or more actions, the machine executable instructions, when executed by the processor further configure the data center node to:
determine if the request includes a get-current-type request associated with the data item;
upon determining the data item has a data type at least in part based on the priority sequence, report the data type associated with the data item; and
upon determining the data item has no data type, report the data item has no data type.

11. The data center node according to claim 9, wherein while performing one or more actions, the machine executable instructions, when executed by the processor further configure the data center node to:
determine if the request includes a clear request associated with the data item; and
upon determining the request is a clear request:
clear one or more values associated with the data item;
clear one or more attributes associated with the data item;
build a merge-clear message based on the clearing of the one or more values and the one or more attributes; and
send a merge-clear request associated with the data item to all other data center nodes in the database system.

12. The data center node according to claim 9, wherein while performing one or more actions, the machine executable instructions, when executed by the processor further configure the data center node to:
upon determining the request is a not a clear request, determine if the data item has a data type; and
upon determining the data item has no data type and the request has a meaning:
apply a change to a value associated with the data item as defined by the request;
apply a change to an attribute associated with the data item as defined by the request; and
send a merge request associated with the data item to all other data center nodes in the database system.

13. The data center node according to claim 9, wherein while performing one or more actions, the machine executable instructions, when executed by the processor further configure the data center node to:
upon determining the data item has a data type at least in part based on the priority sequence and a current data type associated with the data item matches a data type defined in the request:
apply a change to a value associated with the data item as defined by the request;
apply a change to an attribute associated with the data item as defined by the request; and
send a merge request associated with the data item to all other data center nodes in the database system.

14. The data center node according to claim 9, wherein while performing one or more actions, the machine executable instructions, when executed by the processor further configure the data center node to:
upon determining the data item has a data type based at least in part on the priority sequence and a current data type associated with the data item is different than a data type defined in the request:
reject the request.

15. A database system comprising:
a plurality of data base center nodes, each of the data center nodes comprising:
a processor; and
a memory including machine executable instructions stored thereon, the machine executable instructions, when executed by the processor configure a particular data center node to:
receive a request message defining a request relating to a data item, the data item defined without a data type or defined with one or more data types, wherein a priority sequence is associated with the one or more data types; and
perform one or more actions based on an evaluation of the request.

16. The database system according to claim 15 wherein while performing one or more actions, the machine executable instructions, when executed by the processor further configure the particular data center node to:
determine if the request includes a get-current-type request associated with the data item;
upon determining the data item has a data type based at least in part on the priority sequence, report the data type associated with the data item; and
upon determining the data item has no data type, report the data item has no data type.

17. The database system according to claim 15, wherein while performing one or more actions, the machine executable instructions, when executed by the processor further configure the particular data center node to:
determine if the request includes a clear request associated with the data item; and
upon determining the request is a clear request:
clear one or more values associated with the data item;
clear one or more attributes associated with the data item;
build a merge-clear message based on the clearing of the one or more values and the one or more attributes; and
send a merge-clear request associated with the data item to all other data center nodes in the database system.

18. The database system according to claim 15, wherein while performing one or more actions, the machine executable instructions, when executed by the processor further configure the particular data center node to:
upon determining the request is a not a clear request, determine if the data item has a data type; and
upon determining the data item has no data type and the request has a meaning:
apply a change to a value associated with the data item as defined by the request;
apply a change to an attribute associated with the data item as defined by the request; and
send a merge request associated with the data item to all other data center nodes in the database system.

19. The database system according to claim 15, wherein while performing one or more actions, the machine executable instructions, when executed by the processor further configure the particular data center node to:
upon determining the data item has a data type at least in part based on the priority sequence and a current data type associated with the data item matches a data type defined in the request:
apply a change to a value associated with the data item as defined by the request;
apply a change to an attribute associated with the data item as defined by the request;
send a merge request associated with the data item to all other data center nodes in the database system.

20. The database system according to claim 15, wherein while performing one or more actions, the machine executable instructions, when executed by the processor further configure the particular data center node to:
upon determining the data item has a data type based at least in part on the priority sequence and a current data type associated with the data item is different than a data type defined in the request:
reject the request.
